(19) United States
(12) Patent Application Publication
(10) Pub. No.: US 2026/0160346 A1
(43) Pub. Date: Jun. 11, 2026

(54) VALVE ASSEMBLY

(71) Applicants: HYUNDAI MOTOR COMPANY, Seoul (KR); KIA CORPORATION, Seoul (KR)

(72) Inventors: Eon Soo Yun, Hwaseong-si (KR); Dongseok Oh, Hwaseong-si (KR); Seong-Bin Jeong, Hwaseong-si (KR); Yong Woong Cha, Hwaseong-si (KR); Jungha Park, Hwaseong-si (KR)

(73) Assignees: HYUNDAI MOTOR COMPANY, Seoul (KR); KIA CORPORATION, Seoul (KR)

(21) Appl. No.: 19/235,176

(22) Filed: Jun. 11, 2025

(30) Foreign Application Priority Data
Dec. 9, 2024 (KR) 10-2024-0181540

(51) Int. Cl. F16K 11/085; F16K 27/06

(52) U.S. Cl. CPC F16K 11/0856; F16K 27/065

(57) ABSTRACT

A valve assembly includes: a valve housing including a plurality of housing ports; a valve manifold provided in the valve housing and including a plurality of communication holes and a manifold port, which are fluidly connected to the housing port; and a valve body rotatably disposed between the valve housing and the valve manifold. The valve body includes a plurality of channels selectively and fluidly connected to a plurality of communication holes, based on rotation of the valve body. In particular, coolant channels of the valve body, the communication hole of the valve manifold, and the housing ports of the valve housing cooperate to form a plurality of coolant flow paths.

### CROSS-REFERENCE TO RELATED APPLICATION

This application claims priority to and the benefit of Korean Patent Application No. 10-2024-0181540, filed with the Korean Intellectual Property Office on Dec. 9, 2024, the entire contents of which are incorporated herein by reference.

### BACKGROUND

### (a) Field

The present disclosure relates to a valve assembly.

### (b) Description of the Related Art

An air conditioning system applied to environment-friendly vehicles is usually called a heat pump system.

These heat pump systems are equipped with an electric water pump that pumps a coolant. The electric water pump pumps the coolant by rotating an impeller by using a power generated from a drive motor that operates by electrical energy.

Recently, with the continued development of electric vehicles, the number of components within the vehicle that require the coolant supply has been increasing.

In order to supply the coolant to various components, the path of the coolant flowing in the coolant circuit must be changed through a valve (e.g., a three-way valve or a four-way valve, etc.). However, when arranging the multiple valves in the coolant circuit in this way, a manufacturing cost and an assembly work of the vehicle increase, and the packaging of the components becomes difficult.

The above information disclosed in this Background section is only for enhancement of understanding of the background of the disclosure and therefore it may contain information that does not form the prior art that is already known to a person of ordinary skill in the art.

### SUMMARY

The task to be solved is to provide a valve assembly capable of changing the path of the coolant flowing in the coolant circuit.

According to an embodiment of the present disclosure, a valve assembly includes: a valve housing including a plurality of housing ports; a valve manifold disposed in the valve housing and including a plurality of communication holes and a manifold port, which are fluidly connected to the housing port; and a valve body configured to rotate between the valve housing and the valve manifold. The valve body includes a plurality of channels selectively and fluidly connected to the plurality of communication holes. In particular, based on rotation of the valve body, a plurality of coolant channels of the valve body, the plurality of communication holes of the valve manifold, and the plurality of housing ports of the valve housing cooperate to form a plurality of coolant flow paths.

In some embodiments, the plurality of communication holes of the valve manifold may include a first communication hole to a fifth communication hole formed sequentially along an axial direction; and a sixth communication hole to a ninth communication hole formed sequentially adjacent to the first to fifth communication holes in a circumferential direction.

In some embodiments, the manifold port of the valve manifold may further include a first manifold port fluidly connected to the third communication hole; a second manifold port fluidly connected to the eighth communication hole; and a third manifold port fluidly connected to the ninth communication hole.

In some embodiments, the valve housing may include a first valve housing in which the plurality of housing ports are formed; and a second valve housing which combines with the first valve housing to form the appearance of the valve housing.

In some embodiments, the plurality of housing ports may include: a first housing port fluidly connected to the first communication hole of the valve manifold; a second housing port fluidly connected to the second communication hole of the valve manifold; a third housing port fluidly connected to the fourth communication hole of the valve manifold; a fourth housing port fluidly connected to the fifth communication hole of the valve manifold; a fifth housing port fluidly connected to the sixth communication hole of the valve manifold; and a sixth housing port fluidly connected to the seventh communication hole of the valve manifold.

In some embodiments, the valve body may include a central channel formed along a rotation axis of the valve body; and at least one channel assembly including a plurality of channels that are selectively and fluidly connected to at least one of the first to ninth communication holes, selectively and fluidly connected to the central channel, and formed in multiple numbers along the circumferential direction.

In some embodiments, the valve body may include a first channel assembly to a fifth channel assembly that are formed sequentially along the circumferential direction, and one of the first to fifth channel assemblies may cooperate with the valve manifold and the valve housing to form a plurality of coolant flow paths based on the rotation of the valve body,

In some embodiments, the valve assembly may operate in one of a first mode to a fifth mode based on the rotation of the valve body. The first mode may be a mode in which the first channel assembly, the valve manifold, and the valve housing cooperate to form a plurality of coolant flow paths, and the second mode may be a mode in which the second channel assembly, the valve manifold, and the valve housing cooperate to form a plurality of coolant flow paths. The third mode may be a mode in which the third channel assembly, the valve manifold, and the valve housing cooperate to form a plurality of coolant flow paths, and the fourth mode may be a mode in which the fourth channel assembly, the valve manifold, and the valve housing cooperate to form a plurality of coolant flow paths. The fifth mode may be a mode in which the fifth channel assembly, the valve manifold, and the valve housing cooperate to form a plurality of coolant flow paths.

In some embodiments, the first channel assembly may include an eleventh channel fluidically connecting the third communication hole and the fourth communication hole; a twelfth channel fluidly connecting the sixth communication hole and the seventh communication hole; and a thirteenth channel fluidly connecting the eighth communication hole, the ninth communication hole, and the central channel.

In some embodiments, in the first mode, the third housing port, the fourth communication hole, the eleventh channel, the third communication hole, and the first manifold port may be fluidly connected, the sixth housing port, the seventh communication hole, the twelfth channel, the sixth communication hole, and the fifth housing port may be fluidly connected, the third manifold port, the ninth communication hole, the thirteenth channel, the eighth communication hole, and the second manifold port may be fluidly connected, and the third manifold port, the ninth communication hole, the thirteenth channel, and the central channel may be fluidly connected.

In some embodiments, the second channel assembly may include: a twenty-first channel fluidly connects the first communication hole and the central channel; a twenty-second channel fluidly connecting the second communication hole and the third communication hole; a twenty-third channel fluidly connecting the fourth communication hole and the seventh communication hole; a twenty-fourth channel fluidically connecting the fifth communication hole and the sixth communication hole; and a twenty-fifth channel fluidly connecting the eighth communication hole and the ninth communication hole;

In some embodiments, in the second mode, the first housing port, the first communication hole, the twenty-first channel, and the central channel may be fluidly connected, the second housing port, the second communication hole, the twenty-second channel, the third communication hole and the first manifold port may be fluidly connected, the sixth housing port, the seventh communication hole, the twenty-third channel, the fourth communication hole, and the third housing port may be fluidly connected, the fourth housing port, the fifth communication hole, the twenty-fourth channel, the sixth communication hole, and the fifth housing port may be fluidly connected, and the third manifold port, the ninth communication hole, the twenty-fifth channel, the eighth communication hole, and the second manifold port may be fluidly connected.

In some embodiments, the third channel assembly may include: a thirty-first channel that fluidly connects the first communication hole and the central channel; a thirty-second channel fluidly connecting the third communication hole and the ninth communication hole; a thirty-third channel fluidly connecting the fourth communication hole and the eighth communication hole; and a thirty-fourth channel that fluidly connects the sixth communication hole and the seventh communication hole.

In some embodiments, in the third mode, the first housing port, the first communication hole, the thirty-first channel, and the central channel may be fluidly connected, the third manifold port, the ninth communication hole, the thirty-second channel, the third communication hole, and the first manifold port may be fluidly connected, the third housing port, the fourth communication hole, the thirty-third channel, the eighth communication hole, and the second manifold port may be fluidly connected, and the sixth housing port, the seventh communication hole, the thirty-fourth channel, the sixth communication hole, and the fifth housing port may be fluidly connected.

In some embodiments, the fourth channel assembly may include: a forty-first channel fluidly connecting the first communication hole and the central channel; a forty-second channel fluidly connecting the third communication hole and the fourth communication hole; a forty-third channel fluidly connecting the sixth communication hole and the seventh communication hole; and a forty-fourth channel fluidly connecting the eighth communication hole and the ninth communication hole.

In some embodiments, in the fourth mode, the first housing port, the first communication hole, the forty-first channel, and the central channel may be fluidly connected, the third housing port, the fourth communication hole, the forty-second channel, the third communication hole, and the first manifold port may be fluidly connected, the fifth housing port, the sixth communication hole, the forty-third channel, the seventh communication hole, and the sixth housing port may be fluidly connected, and the third manifold port, the ninth communication hole, the forty-fourth channel, the eighth communication hole, and the second manifold port may be fluidly connected.

In some embodiments, the fifth channel assembly may include: a fifty-first channel fluidly connecting the third communication hole, the ninth communication hole, and the central channel; a fifty-second channel fluidly connecting the fourth communication hole and the eighth communication hole; and a fifty-third channel fluidly connecting the sixth communication hole and the seventh communication hole.

In some embodiments, in the fifth mode, the third manifold port, the ninth communication hole, the fifty-first channel, the third communication hole, and the first manifold port may be fluidly connected, the third manifold port, the ninth communication hole, the fifty-first channel, and the central channel may be fluidly connected, the third housing port, the fourth communication hole, the fifty-second channel, the eighth communication hole, and the second manifold port may be fluidly connected, and the sixth housing port, the seventh communication hole, the fifty-third channel, the sixth communication hole, and the fifth housing port may be fluidly connected.

In another embodiment, a valve assembly comprises: a valve housing including a plurality of housing ports; a valve manifold disposed in the valve housing and including a plurality of communication holes and at least one manifold port, the communication holes being fluidly connectable to the plurality of housing ports; and a valve body rotatably disposed between the valve housing and the valve manifold. The valve body includes: a central channel formed along a rotational axis of the valve body, and a plurality of channel assemblies formed at multiple positions in a circumferential direction of the valve body, each channel assembly including a plurality of channels selectively and fluidly connectable to at least one of the plurality of communication holes and to the central channel. In particular, based on rotation of the valve body, one of the plurality of channel assemblies cooperates with the valve manifold and the valve housing to form a plurality of distinct coolant flow paths.

In an embodiment, the rotation of the valve body into different angular positions causes respective ones of the plurality of channel assemblies to be fluidly aligned with selected communication holes of the plurality of communication holes and housing ports of the plurality of housing ports, such that the valve assembly operates in a corresponding plurality of modes, each mode forming a distinct set of coolant flow paths.

According to the embodiments of the present disclosure, the plurality of coolant flow paths may be formed through the valve body, the valve manifold, and the valve housing, thereby changing the path of the coolant flowing in the coolant circuit in various ways.

With this configuration, a manufacturing cost and an assembly work of the vehicle may be reduced, and the components that make up the coolant circuit may be easily packaged.

Further, effects that can be obtained or expected from embodiments of the present disclosure are directly or suggestively described in the following detailed description. Various effects expected from the embodiments of the present disclosure are described in the following detailed description.

### BRIEF DESCRIPTION OF THE DRAWINGS

The drawings are provided for reference to explain illustrative embodiments of the present disclosure, and the technical spirit of the present disclosure should not be interpreted to be limited to the accompanying drawings.

FIG. 1 and FIG. 2 are perspective views illustrating a configuration of a valve assembly according to an embodiment.

FIG. 3 is an exploded perspective view illustrating a configuration of a valve assembly according to an embodiment.

FIG. 4 and FIG. 5 are views showing a configuration of a valve manifold according to an embodiment.

FIG. 6 is a perspective view illustrating a configuration of a first valve housing according to an embodiment.

FIG. 7 and FIG. 8 are perspective views illustrating a configuration of a valve body according to an embodiment.

FIG. 9 and FIG. 10 are cross-sectional views illustrating a configuration of a valve body according to an embodiment.

FIG. 11A is a view illustrating a first channel assembly of a valve body according to an embodiment.

FIG. 11B is a view illustrating a relationship between a first channel assembly of a valve body and a valve manifold according to an embodiment.

FIG. 11C is a drawing illustrating a coolant flow path in a first mode according to an embodiment.

FIG. 12A is a view illustrating a second channel assembly of a valve body according to an embodiment.

FIG. 12B is a view illustrating a relationship between a second channel assembly of a valve body and a valve manifold according to an embodiment.

FIG. 12C is a view illustrating a coolant flow path in a second mode according to an embodiment.

FIG. 13A is a view illustrating a third channel assembly of a valve body according to an embodiment.

FIG. 13B is a view illustrating a relationship between a third channel assembly of a valve body and a valve manifold according to an embodiment.

FIG. 13C is a view illustrating a coolant flow path in a third mode according to an embodiment.

FIG. 14A is a view illustrating a fourth channel assembly of a valve body according to an embodiment.

FIG. 14B is a view illustrating a relationship between a fourth channel assembly of a valve body and a valve manifold according to an embodiment.

FIG. 14C is a view illustrating a coolant flow path in a fourth mode according to an embodiment.

FIG. 15A is a view illustrating a fifth channel assembly of a valve body according to an embodiment.

FIG. 15B is a view illustrating a relationship between a fifth channel assembly of a valve body and a valve manifold according to an embodiment.

FIG. 15C is a view illustrating a coolant flow path in a fifth mode according to an embodiment.

The drawings referenced above are not necessarily drawn to scale and are to be understood as presenting rather simplified representations of various features that illustrate basic principles of the present disclosure. Certain design features of the present disclosure, including, for example, particular dimensions, directions, positions, and shapes will be determined in part by particular intended applications and use environments.

### DETAILED DESCRIPTION

The terminology used herein is for the purpose of describing particular embodiments only, and is not intended to limit the present disclosure. As used herein, singular forms are intended to also include a plurality of forms, unless the context clearly indicates otherwise. It should be further understood that term “comprises” or “have” used in the present specification specify the presence of stated features, numerals, steps, operations, components, parts, or a combination thereof, but does not preclude the presence or addition of one or more other features, numerals, steps, operations, components, parts, or a combination thereof. Also, as used herein, the term “and/or” includes any plurality of combinations of items or any of a plurality of listed items.

The present disclosure is described more fully hereinafter with reference to the accompanying drawings, in which embodiments of the disclosure are shown. As those having ordinary skill in the art would realize, the described embodiments may be modified in various different ways, all without departing from the spirit or scope of the present disclosure.

Descriptions of parts not related to the present disclosure are omitted, and like reference numerals designate like elements throughout the specification.

Further, since sizes and thicknesses of constituent members shown in the accompanying drawings are arbitrarily given for better understanding and ease of description, the present disclosure is not limited to the illustrated sizes and thicknesses, and the thickness is enlarged to clearly express various parts and regions.

The terms “module” and “unit” for components used in the following description are used only in order to easily make a specification. Therefore, these terms do not have meanings or roles that distinguish them from each other in themselves.

Further, in describing embodiments of the present specification, when it is determined that a detailed description of the well-known art associated with the present disclosure may obscure the gist of the present disclosure, it has been omitted.

In addition, the accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like are used only to describe various components, and are not interpreted as limiting these components.

In the explanations below, expressions written in the singular may be interpreted as either singular or plural, unless explicit expressions such as “one” or “singular” are used.

The terms are only used to differentiate one component from other components.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

Below, a valve assembly according to an embodiment is described in detail with reference to attached drawings.

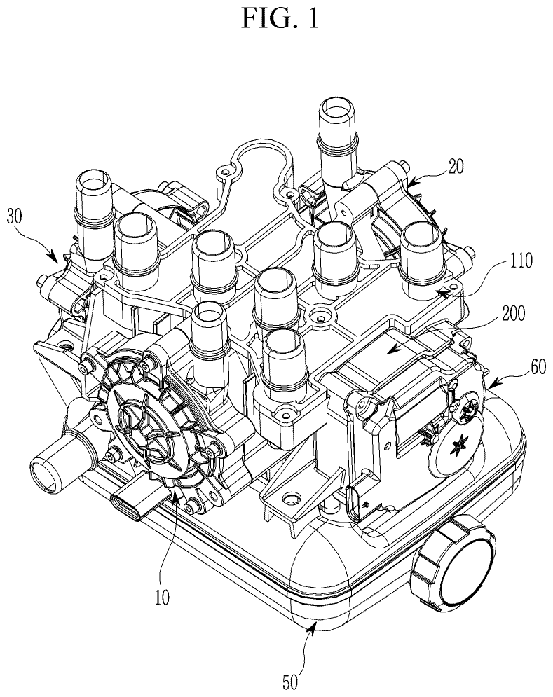

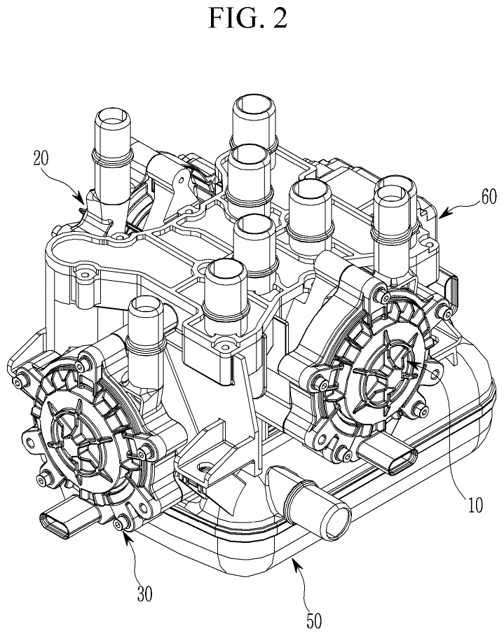

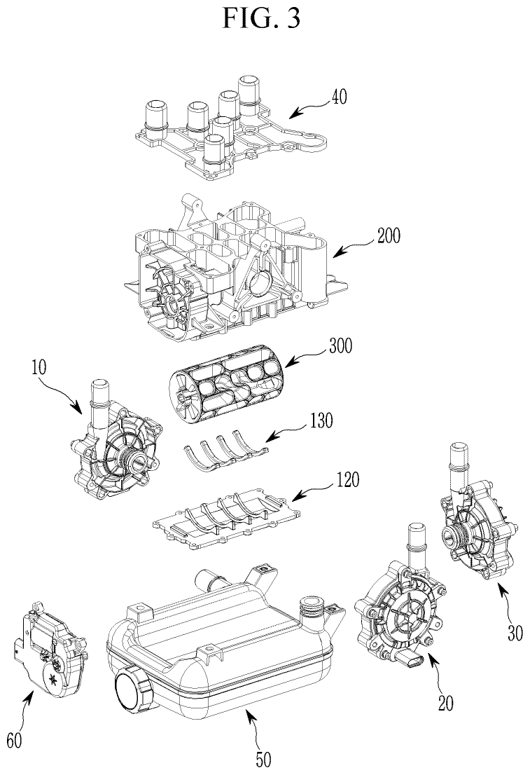

FIG. 1 and FIG. 2 are perspective views illustrating a configuration of a valve assembly according to an embodiment. Also, FIG. 3 is an exploded perspective view showing a configuration of a valve assembly according to an embodiment.

A valve assembly according to an embodiment, as shown in FIG. 1 to FIG. 3, may include a valve housing 100, a valve manifold 200, and a valve body 300.

The valve housing 100 may form the overall appearance of the valve assembly and may include a first valve housing 110 and a second valve housing 120. The first valve housing 110 may be provided on the second valve housing 120, and the first valve housing 110 and the second valve housing 120 may be combined to form the appearance of the valve assembly.

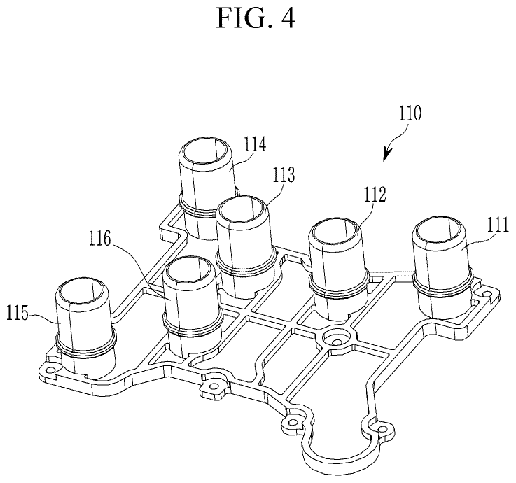

Referring to FIG. 4, the first valve housing 110 may have a plurality of housing ports. The coolant may be inflowed or discharged through the housing port.

The housing ports formed in the first valve housing 110 may include the first housing port 111 to the sixth housing port 116.

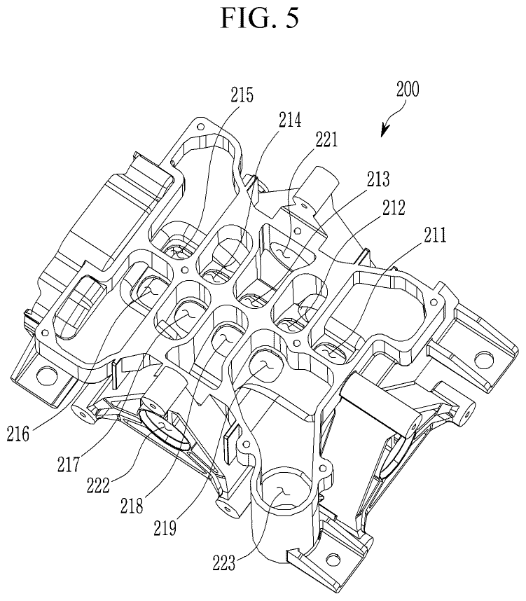

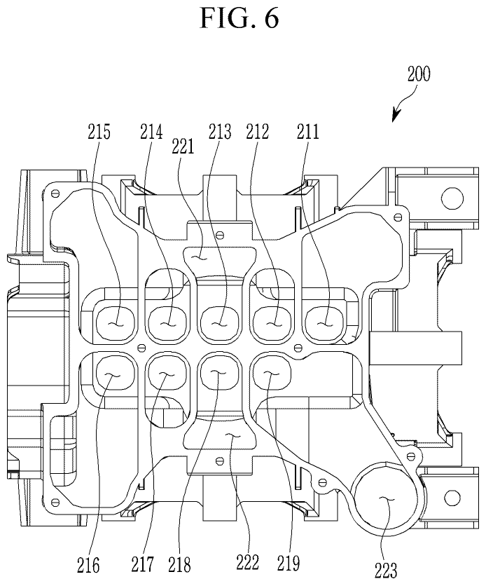

Referring to FIG. 5 and FIG. 6, the valve manifold 200 may be provided between the valve housing 100 and include a plurality of communication holes fluidly connected to the housing ports of the valve housing 100. Also, the valve manifold 200 may be formed with a manifold port that is fluidly connected to at least one of the plurality of communication holes.

In an embodiment, the communication holes formed in the valve manifold 200 may include a first communication hole 211 to a ninth communication hole 219. The first communication hole 211 to the fifth communication hole 215 may be formed sequentially along the rotation axis 301 (i.e., an axial direction) of the valve body 300, and the sixth communication hole 216 to the ninth communication hole 219 may be formed sequentially adjacent to the first communication hole 211 to the fifth communication hole 215 in the circumferential direction of the valve body 300.

The manifold ports formed on the valve manifold 200 may include a first manifold port 221 to a third manifold port 223. The first manifold port 221 may be fluidly connected to the third communication hole 213, the second manifold port 222 may be fluidly connected to the eighth communication hole 218, and the third manifold port 223 may be fluidly connected to the ninth communication hole 219. The coolant may be inflowed or discharged through the first manifold port 221 to the third manifold port 223.

In an embodiment, a first water pump 10 may be mounted in the first manifold port 221, a second water pump 20 may be mounted in the second manifold port 222, and a reservoir tank 50 may be mounted in the third manifold port 223.

In an embodiment, the first communication hole 211 may be fluidly connected to the first housing port 111, the second communication hole 212 may be fluidly connected to the second housing port 112, the third communication hole 213 may be fluidly connected to the first manifold port 221, the fourth communication hole 214 may be fluidly connected to the third housing port 113, the fifth communication hole 215 may be fluidly connected to the fourth housing port 114, the sixth communication hole 216 may be fluidly connected to the fifth housing port 115, the seventh communication hole 217 may be fluidly connected to the sixth housing port 116, the eighth communication hole 218 may be fluidly connected to the second manifold port 222, and the ninth communication hole 219 may be fluidly connected to the third manifold port 223.

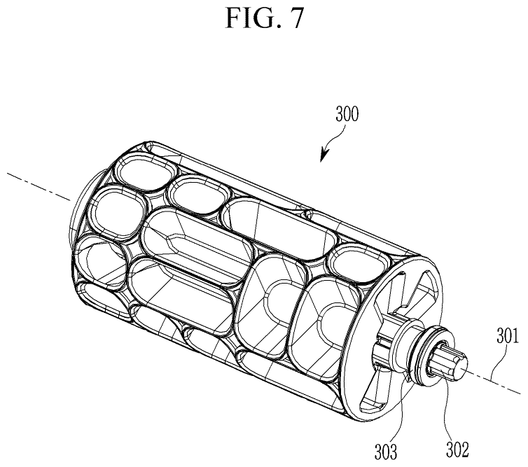

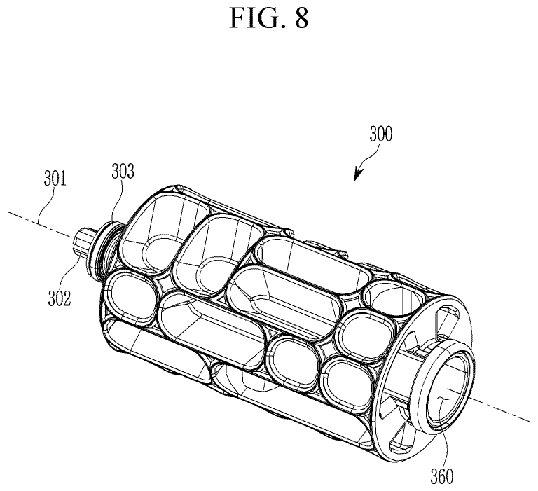

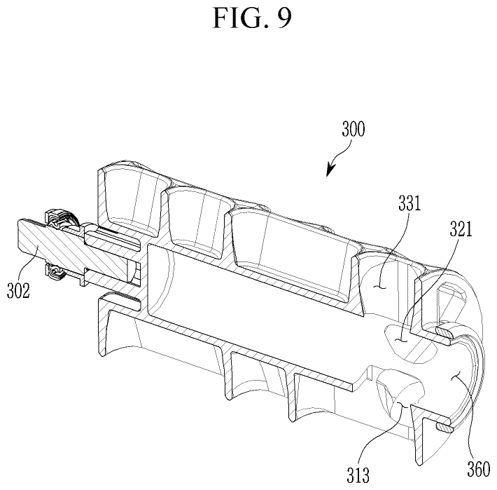

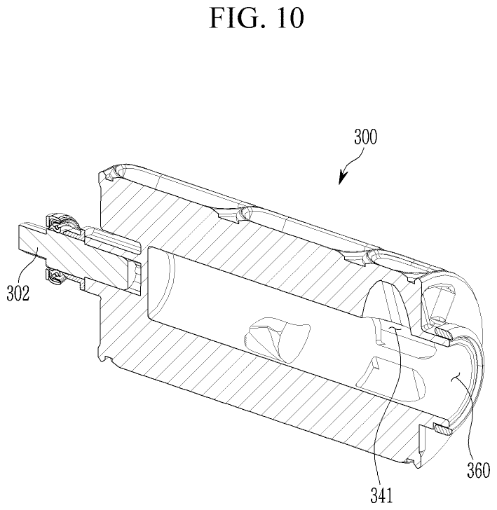

Referring FIG. 7 to FIG. 10, the valve body 300 may be rotatably disposed between the valve housing 100 and the valve manifold 200 and may be formed into an approximately cylindrical shape. The valve body 300 may be rotated to a predetermined angle by the driver 60. The driver 60 may be implemented as any one of an electric motor, a hydraulic pressure motor, and a solenoid.

An axial rod 302 is formed by protruding from the end of the valve body 300, and the axial rod 302 may be rotatably connected to the valve manifold 200. The axial rod 302 of the valve body 300 is equipped with a sealing member 303, and the coolant may be prevented from leaking through the sealing member 303. The sealing member 303 provided in the valve body 300 may be a lip seal.

A plurality of coolant channels may be formed in the valve body 300. The plurality of coolant channels formed in the valve body 300 may include a central channel formed along the rotation axis 301 of the valve body 300, and a plurality of channel assemblies. The plurality of channel assemblies may include a plurality of channels being selectively and fluidly connected to at least one of the first communication hole 211 to the ninth communication hole 219, selectively and fluidly connected to the central channel, and formed along the circumferential direction of the valve body 300. In an embodiment, the third water pump 30 may be mounted in the central channel.

The plurality of channel assemblies may include a first channel assembly 310 to a fifth channel assembly 350 that are sequentially formed along the circumferential direction of the valve body 300. Depending on the rotation of the valve body 300, any one of the first channel assembly 310 to fifth channel assembly 350 may cooperate with the valve manifold 200 and the valve housing 100 to form a plurality of coolant flow paths.

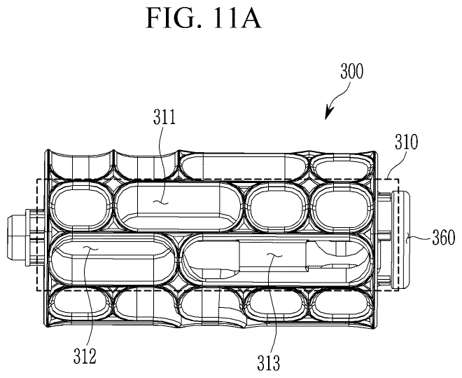

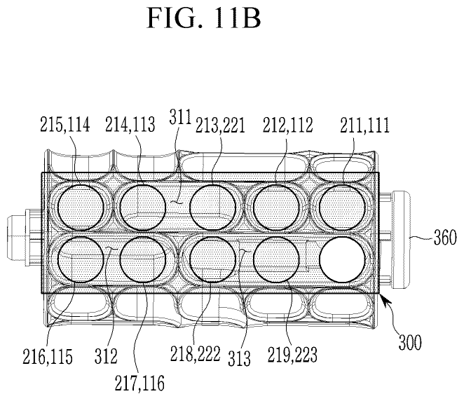

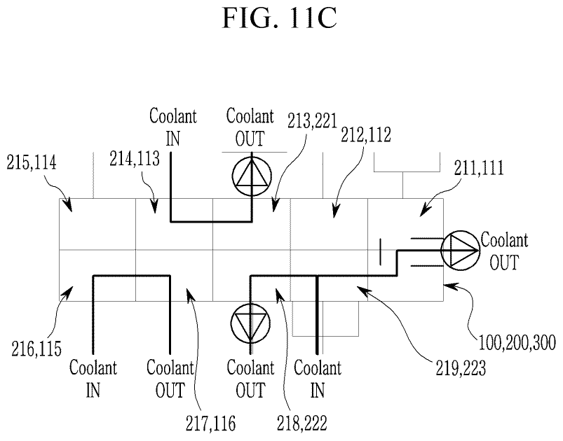

Referring to FIG. 11A and FIG. 11B, the first channel assembly 310 may include an eleventh channel 311 to a thirteenth channel 313. The eleventh channel 311 may fluidly connect the third communication hole 213 and the fourth communication hole 214. The twelfth channel 312 may fluidly connect the sixth communication hole 216 and the seventh communication hole 217. Also, the thirteenth channel 313 may fluidly connect the eighth communication hole 218, the ninth communication hole 219, and the central channel.

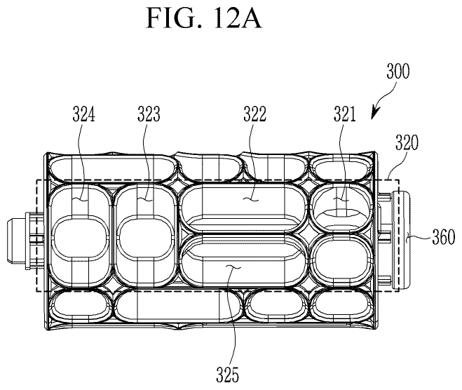

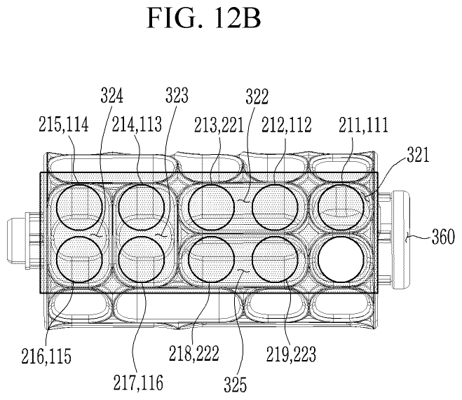

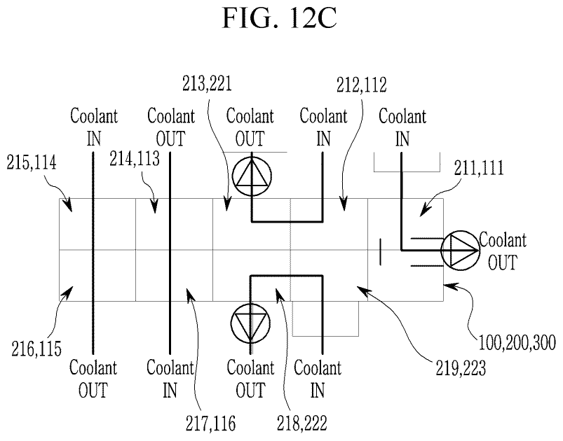

Referring to FIG. 12A and FIG. 12B, the second channel assembly 320 may include a twenty-first channel 321 to a twenty-fifth channel 325. The twenty-first channel 321 may fluidly connect the first communication hole 211 and the central channel. The twenty-second channel 322 may fluidly connect the second communication hole 212 and the third communication hole 213. The twenty-third channel 323 may fluidly connect the fourth communication hole 214 and the seventh communication hole 217. The twenty-fourth channel 324 may fluidly connect the fifth communication hole 215 and the sixth communication hole 216. Also, the twenty-fifth channel 325 may fluidly connect the eighth communication hole 218 and the ninth communication hole 219.

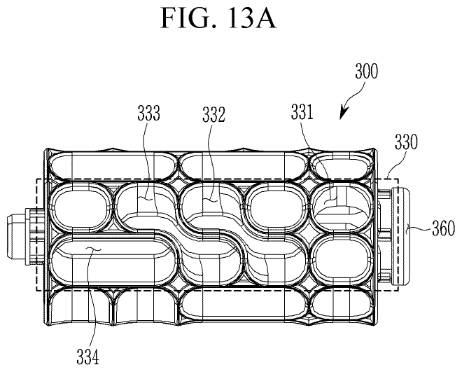

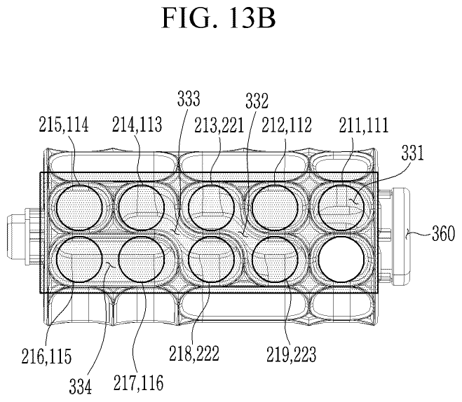

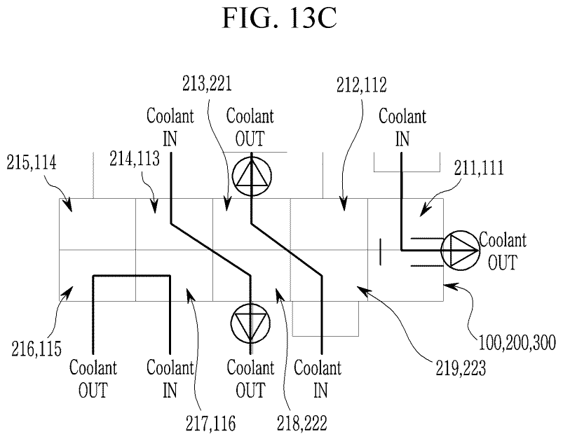

Referring to FIG. 13A and FIG. 13B, the third channel assembly 330 may include a thirty-first channel 331 to a thirty-fourth channel 334. The thirty-first channel 331 may fluidly connect the first communication hole 211 and the central channel. The thirty-second channel 332 may fluidly connect the third communication hole 213 and the ninth communication hole 219. The thirty-third channel 333 may fluidly connect the fourth communication hole 214 and the eighth communication hole 218. Also, the thirty-fourth channel 334 may fluidly connect the sixth communication hole 216 and the seventh communication hole 217.

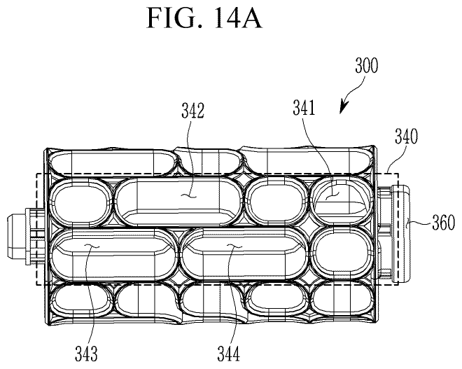

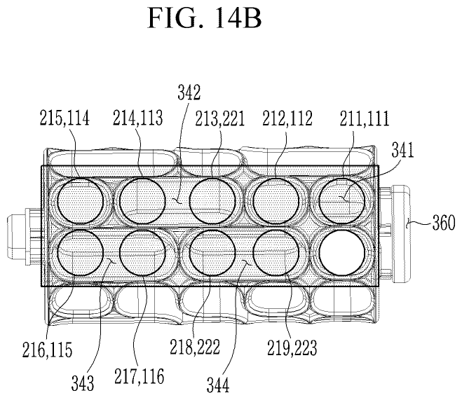

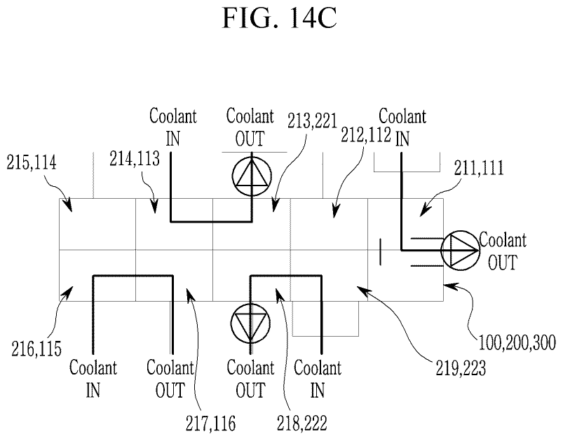

Referring to FIG. 14A and FIG. 14B, the fourth channel assembly 340 may include a forty-first channel 341 to a forty-fourth channel 344. The forty-first channel 341 can fluidly connect the first communication hole 211 and the central channel. The forty-second channel 342 may fluidly connect the third communication hole 213 and the fourth communication hole 214. The forty-third channel 343 may fluidly connect the sixth communication hole 216 and the seventh communication hole 217. Also, the forty-fourth channel 344 may fluidly connect the eighth communication hole 218 and the ninth communication hole 219.

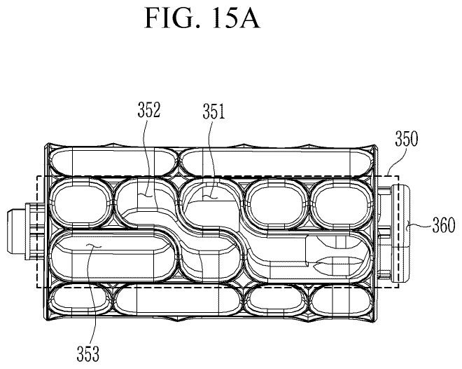

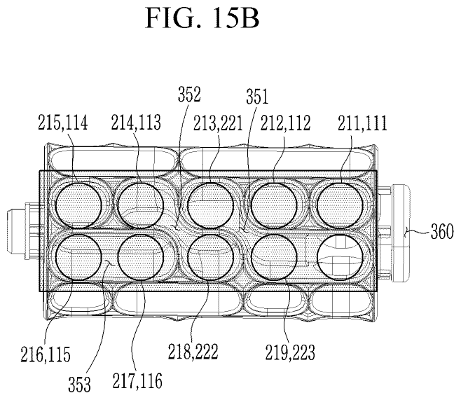

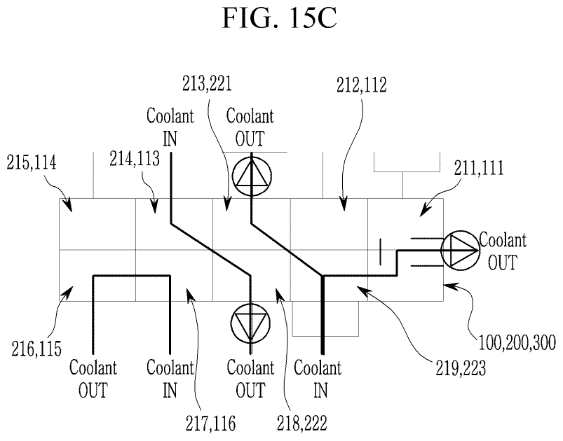

Referring to FIG. 15A and FIG. 15B, the fifth channel assembly 350 may include a fifty-first channel 351 to a fifty-third channel 353. The fifty-first channel 351 may fluidly connect the third communication hole 213, the ninth communication hole 219, and the central channel. The fifty-second channel 352 may fluidly connect the fourth communication hole 214 and the eighth communication hole 218. Also, the fifty-third channel 353 may fluidly connect the sixth communication hole 216 and the seventh communication hole 217.

In an embodiment, each coolant channel may be formed in a circular or oval shape. Since the coolant channel is formed in the circular or oval shape, a surface pressure applied to the valve body 300 may be maintained constant when the coolant flows in and out.

In an embodiment, a valve supporter 130 may be provided between the valve body 300 and the first valve housing 110. The valve supporter 130 may stably support the valve body 300 when the valve body 300 rotates.

Hereinafter, the operation of the valve assembly according to an embodiment is described in detail with reference to attached drawings.

A valve assembly according to an embodiment may be operated in any one of the first mode to the fifth mode while being rotated by a predetermined angle (e.g., 72 degrees) by a driver 60.

The first mode may be a mode in which the first channel assembly 310, the valve manifold 200, and the valve housing 100 cooperate to form a plurality of coolant flow paths. The second mode may be a mode in which the second channel assembly 320, the valve manifold 200, and the valve housing 100 cooperate to form a plurality of coolant flow paths. The third mode may be a mode in which the third channel assembly 330, the valve manifold 200, and the valve housing 100 cooperate to form a plurality of coolant flow paths. The fourth mode may be a mode in which the fourth channel assembly 340, the valve manifold 200, and the valve housing 100 cooperate to form a plurality of coolant flow paths. Also, the fifth mode may be a mode in which the fifth channel assembly 350, the valve manifold 200, and the valve housing 100 cooperate to form a plurality of coolant flow paths.

The first mode may refer to a state where the valve body 300 is positioned at the reference position.

The second mode may refer to a state where the valve body 300 is rotated by a predetermined angle (e.g., 72 degrees) in a predetermined direction (e.g., a clockwise direction) from the reference position. The third mode may refer to a state where the valve body 300 is rotated by a predetermined angle (e.g., 144 degrees) in a predetermined direction (e.g., a clockwise direction) from the reference position. The fourth mode may refer to a state where the valve body 300 is rotated from the reference position in a predetermined direction (e.g., a clockwise direction) by a predetermined angle (e.g., 216 degrees). Also, the fifth mode may refer to a state where the valve body 300 is rotated by a predetermined angle (e.g., 288 degrees) in a predetermined direction (e.g., a clockwise direction) from the reference position. In other words, the first mode to fifth mode may be implemented while the valve body 300 rotates with the predetermined angle (e.g., 72 degrees).

Referring to FIG. 11A to FIG. 11C, in the first mode, the third housing port 113, the fourth communication hole 214, the eleventh channel 311, the third communication hole 213, and the first manifold port 221 may be fluidly connected, and the third housing port 113, the fourth communication hole 214, the eleventh channel 311, the third communication hole 213, and the first manifold port 221 may form a first-first coolant flow path. Accordingly, the coolant inflowing into the third housing port 113 may be discharged to the first manifold port 221 through the fourth communication hole 214, the eleventh channel 311, and the third communication hole 213.

The sixth housing port 116, the seventh communication hole 217, the twelfth channel 312, the sixth communication hole 216, and the fifth housing port 115 may be fluidly connected, and the sixth housing port 116, the seventh communication hole 217, the twelfth channel 312, the sixth communication hole 216, and the fifth housing port 115 may form a first-second coolant flow path. Accordingly, the coolant inflowing into the sixth housing port 116 may be discharged into the fifth housing port 115 through the seventh communication hole 217, the twelfth channel 312, and the sixth communication hole 216.

The third manifold port 223, the ninth communication hole 219, the thirteenth channel 313, the eighth communication hole 218, and the second manifold port 222 may be fluidically connected, and the third manifold port 223, the ninth communication hole 219, the thirteenth channel 313, the eighth communication hole 218, and the second manifold port 222 may form a first-third coolant flow path. Accordingly, the coolant inflowing into the third manifold port 223 may be discharged into the second manifold port 222 through the ninth communication hole 219, the thirteenth channel 313, and the eighth communication hole 218.

The third manifold port 223, the ninth communication hole 219, the thirteenth channel 313, and the central channel are fluidically connected, and the third manifold port 223, the ninth communication hole 219, the thirteenth channel 313, and the central channel may form a first-fourth coolant flow path. Accordingly, the coolant inflowing into the third manifold port 223 may be discharged to the central channel through the ninth communication hole 219 and the thirteenth channel 313.

Referring to FIG. 12A to FIG. 12C, in the second mode, the first housing port 111, the first communication hole 211, the twenty-first channel 321, and the central channel may be fluidically connected, and the first housing port 111, the first communication hole 211, the twenty-first channel 321, and the central channel may form a second-first coolant flow path. Accordingly, the coolant inflowing into the first housing port 111 may be discharged to the central channel through the first communication hole 211 and the twenty-first channel 321.

The second housing port 112, the second communication hole 212, the twenty-second channel 322, the third communication hole 213, and the first manifold port 221 may be fluidically connected, and the second housing port 112, the second communication hole 212, the twenty-second channel 322, the third communication hole 213, and the first manifold port 221 may form a second-second coolant flow path. Accordingly, the coolant inflowing into the second housing port 112 can be discharged into the first manifold port 221 through the second communication hole 212, the twenty-second channel 322, and the third communication hole 213.

The sixth housing port 116, the seventh communication hole 217, the twenty-third channel 323, the fourth communication hole 214, and the third housing port 113 may be fluidically connected, and the sixth housing port 116, the seventh communication hole 217, the twenty-third channel 323, the fourth communication hole 214, and the third housing port 113 may form a second-third coolant flow path. Accordingly, the coolant inflowing into the sixth housing port 116 may be discharged into the third housing port 113 through the seventh communication hole 217, the twenty-third channel 323, and the fourth communication hole 214.

The fourth housing port 114, the fifth communication hole 215, the twenty-fourth channel 324, the sixth communication hole 216, and the fifth housing port 115 may be fluidically connected, and the fourth housing port 114, the fifth communication hole 215, the twenty-fourth channel 324, the sixth communication hole 216, and the fifth housing port 115 may form a second-fourth coolant flow path. Accordingly, the coolant inflowing into the fourth housing port 114 may be discharged into the fifth housing port 115 through the fifth communication hole 215, the twenty-fourth channel 324, and the sixth communication hole 216.

The third manifold port 223, the ninth communication hole 219, the twenty-fifth channel 325, the eighth communication hole 218, and the second manifold port 222 may be fluidically connected, and the third manifold port 223, the ninth communication hole 219, the twenty-fifth channel 325, the eighth communication hole 218, and the second manifold port 222 may form a second-fifth coolant flow path. Accordingly, the coolant inflowing into the third manifold port 223 may be discharged into the second manifold port 222 through the ninth communication hole 219, the twenty-fifth channel 325, and the eighth communication hole 218.

Referring to FIG. 13A to FIG. 13C, in the third mode, the first housing port 111, the first communication hole 211, the thirty-first channel 331, and the central channel may be fluidically connected, and the first housing port 111, the first communication hole 211, the thirty-first channel 331, and the central channel may form a third-first coolant flow path. Accordingly, the coolant inflowing into the first housing port 111 may be discharged to the central channel through the first communication hole 211 and the thirty-first channel 331.

The third manifold port 223, the ninth communication hole 219, the thirty-second channel 332, the third communication hole 213, and the first manifold port 221 may be fluidically connected, and the third manifold port 223, the ninth communication hole 219, the thirty-second channel 332, the third communication hole 213, and the first manifold port 221 may form a third-second coolant flow path. Accordingly, the coolant inflowing into the third manifold port 223 may be discharged into the first manifold port 221 through the ninth communication hole 219, the thirty-second channel 332, and the third communication hole 213.

The third housing port 113, the fourth communication hole 214, the thirty-third channel 333, the eighth communication hole 218, and the second manifold port 222 may be fluidically connected, and the third housing port 113, the fourth communication hole 214, the thirty-third channel 333, the eighth communication hole 218, and the second manifold port 222 may form a third-third coolant flow path. Accordingly, the coolant inflowing into the third housing port 113 may be discharged to the second manifold port 222 through the fourth communication hole 214, the thirty-third channel 333, and the eighth communication hole 218.

The sixth housing port 116, the seventh communication hole 217, the thirty-fourth channel 334, the sixth communication hole 216, and the fifth housing port 115 may be fluidically connected, and the sixth housing port 116, the seventh communication hole 217, the thirty-fourth channel 334, the sixth communication hole 216, and the fifth housing port 115 may form a third-fourth coolant flow path. Accordingly, the coolant inflowing into the sixth housing port 116 may be discharged into the fifth housing port 115 through the seventh communication hole 217, the thirty-fourth channel 334, and the sixth communication hole 216.

Referring to FIG. 14A to FIG. 14C, in the fourth mode, the first housing port 111, the first communication hole 211, the forty-first channel 341, and the central channel may be fluidically connected, and the first housing port 111, the first communication hole 211, the forty-first channel 341, and the central channel may form a fourth-first coolant flow path. Accordingly, the coolant inflowing into the first housing port 111 may be discharged to the central channel through the first communication hole 211 and the forty-first channel 341.

The third housing port 113, the fourth communication hole 214, the forty-second channel 342, the third communication hole 213, and the first manifold port 221 may be fluidically connected, and the third housing port 113, the fourth communication hole 214, the forty-second channel 342, the third communication hole 213, and the first manifold port 221 may form a fourth-second coolant flow path. Accordingly, the coolant inflowing into the third housing port 113 may be discharged to the first manifold port 221 through the fourth communication hole 214, the forty-second channel 342, and the third communication hole 213.

The fifth housing port 115, the sixth communication hole 216, the forty-third channel 343, the seventh communication hole 217, and the sixth housing port 116 may be fluidically connected, and the fifth housing port 115, the sixth communication hole 216, the forty-third channel 343, the seventh communication hole 217, and the sixth housing port 116 may form a fourth-third coolant flow path. Accordingly, the coolant inflowing into the fifth housing port 115 may be discharged into the sixth housing port 116 through the sixth communication hole 216, the forty-third channel 343, and the seventh communication hole 217.

The third manifold port 223, the ninth communication hole 219, the forty-fourth channel 344, the eighth communication hole 218, and the second manifold port 222 may fluidically connected, and the third manifold port 223, the ninth communication hole 219, the forty-fourth channel 344, the eighth communication hole 218, and the second manifold port 222 may form a fourth-fourth coolant flow path. Accordingly, the coolant inflowing into the third manifold port 223 may be discharged into the second manifold port 222 through the ninth communication hole 219, the forty-fourth channel 344, and the eighth communication hole 218.

Referring to FIG. 15A to FIG. 15C, in the fifth mode, the third manifold port 223, the ninth communication hole 219, the fifty-first channel 351, the third communication hole 213, and the first manifold port 221 may be fluidically connected, and the third manifold port 223, the ninth communication hole 219, the fifty-first channel 351, the third communication hole 213, and the first manifold port 221 may form a fifth-first coolant flow path. Accordingly, the coolant inflowing into the third manifold port 223 may be discharged into the first manifold port 221 through the ninth communication hole 219, the fifty-first channel 351, and the third communication hole 213.

The third manifold port 223, the ninth communication hole 219, the fifty-first channel 351, and the central channel may fluidically connected, and the third manifold port 223, the ninth communication hole 219, the fifty-first channel 351, and the central channel may form a fifth-second coolant flow path. Accordingly, the coolant inflowing into the third manifold port 223 may be discharged to the central channel through the ninth communication hole 219 and the fifty-first channel 351.

The third housing port 113, the fourth communication hole 214, the fifty-second channel 352, the eighth communication hole 218, and the second manifold port 222 may be fluidically connected, and the third housing port 113, the fourth communication hole 214, the fifty-second channel 352, the eighth communication hole 218, and the second manifold port 222 may form a fifth-third coolant flow path. Accordingly, the coolant inflowing into the third housing port 113 may be discharged to the second manifold port 222 through the fourth communication hole 214, the fifty-second channel 352, and the eighth communication hole 218.

The sixth housing port 116, the seventh communication hole 217, the fifty-third channel 353, the sixth communication hole 216, and the fifth housing port 115 may be fluidically connected, and the sixth housing port 116, the seventh communication hole 217, the fifty-third channel 353, the sixth communication hole 216, and the fifth housing port 115 may form a fifth-fourth coolant flow path. Accordingly, the coolant inflowing into the sixth housing port 116 may be discharged into the fifth housing port 115 through the seventh communication hole 217, fifty-third channel 353, and sixth communication hole 216.

According to the valve assembly according to an embodiment, the plurality of coolant flow paths may be formed through the valve body 300, the valve manifold 200, and the valve housing 100 according to the rotation of the valve body 300. With this configuration, the path of the coolant flowing through the coolant circuit may be varied, and the manufacturing cost and the assembly work of the vehicle may be reduced.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

10: first water pump
20: second water pump
30: third water pump
50: reservoir tank
60: driver
100: valve housing
110: first valve housing
111: first housing port
112: second housing port
113: third housing port
114: fourth housing port
115: fifth housing port
116: sixth housing port
120: second valve housing
130: valve supporter
200: valve manifold
211: first communication hole
212: second communication hole
213: third communication hole
214: fourth communication hole
215: fifth communication hole
216: sixth communication hole
217: seventh communication hole
218: eighth communication hole
219: ninth communication hole
221: first manifold port
222: second manifold port
223: third manifold port
300: valve body
301: rotation axis
302: axis rod
303: sealing member
310: first channel assembly
311: eleventh channel
312: twelfth channel
313: thirteenth channel
320: second channel assembly
321: twenty-first channel
322: twenty-second channel
323: twenty-third channel
324: twenty-fourth channel
325: twenty-fifth channel
330: third channel assembly
331: thirty-first channel
332: thirty-second channel
333: thirty-third channel
334: thirty-fourth channel
340: fourth channel assembly
341: forty-first channel
342: forty-second channel
343: forty-third channel
344: forty-fourth channel
350: fifth channel assembly
351: fifty-first channel
352: fifty-second channel
353: fifty-third channel
360: central channel

What is claimed is:

1. A valve assembly comprising:
a valve housing including a plurality of housing ports;
a valve manifold disposed in the valve housing and including a plurality of communication holes and a manifold port, which are fluidly connected to the plurality of housing ports; and
a valve body configured to rotate between the valve housing and the valve manifold, and the valve body including a plurality of channels selectively and fluidly connected to the plurality of communication holes,
wherein based on rotation of the valve body, the plurality of channels of the valve body, the plurality of communication holes of the valve manifold, and the plurality of housing ports of the valve housing are configured to cooperate to form a plurality of coolant flow paths.

2. The valve assembly of claim 1, wherein the plurality of communication holes of the valve manifold includes:
a first communication hole to a fifth communication hole formed sequentially along an axial direction of the valve body; and
a sixth communication hole to a ninth communication hole formed sequentially adjacent to the first to fifth communication holes in a circumferential direction of the valve body.

3. The valve assembly of claim 2, wherein the manifold port of the valve manifold further includes:
a first manifold port fluidly connected to the third communication hole;
a second manifold port fluidly connected to the eighth communication hole; and
a third manifold port fluidly connected to the ninth communication hole.

4. The valve assembly of claim 3, wherein the valve housing includes:
a first valve housing in which the plurality of housing ports are formed; and
a second valve housing configured to be combined with the first valve housing to form an appearance of the valve housing.

5. The valve assembly of claim 4, wherein the plurality of housing ports includes:
a first housing port fluidly connected to the first communication hole of the valve manifold;
a second housing port fluidly connected to the second communication hole of the valve manifold;
a third housing port fluidly connected to the fourth communication hole of the valve manifold;
a fourth housing port fluidly connected to the fifth communication hole of the valve manifold;
a fifth housing port fluidly connected to the sixth communication hole of the valve manifold; and
a sixth housing port fluidly connected to the seventh communication hole of the valve manifold.

6. The valve assembly of claim 5, wherein the valve body includes:
a central channel formed along a rotation axis of the valve body; and
at least one channel assembly including a plurality of channels that are selectively and fluidly connected to at least one of the first to ninth communication holes, selectively and fluidly connected to the central channel, and formed in multiple numbers along the circumferential direction.

7. The valve assembly of claim 5, wherein:
the valve body includes a first channel assembly to a fifth channel assembly that are formed sequentially along the circumferential direction, and
one of the first to fifth channel assemblies is configured to cooperate with the valve manifold and the valve housing to form a plurality of coolant flow paths based on the rotation of the valve body.

8. The valve assembly of claim 7, wherein:
the valve assembly operates in one of a first mode to a fifth mode based on the rotation of the valve body,
the first mode is a mode in which the first channel assembly, the valve manifold, and the valve housing cooperate to form a plurality of coolant flow paths,
the second mode is a mode in which the second channel assembly, the valve manifold, and the valve housing cooperate to form a plurality of coolant flow paths,
the third mode is a mode in which the third channel assembly, the valve manifold, and the valve housing cooperate to form a plurality of coolant flow paths,
the fourth mode is a mode in which the fourth channel assembly, the valve manifold, and the valve housing cooperate to form a plurality of coolant flow paths, and
the fifth mode is a mode in which the fifth channel assembly, the valve manifold, and the valve housing cooperate to form a plurality of coolant flow paths.

9. The valve assembly of claim 8, wherein the first channel assembly includes:
an eleventh channel fluidically connecting the third communication hole and the fourth communication hole;
a twelfth channel fluidly connecting the sixth communication hole and the seventh communication hole; and
a thirteenth channel fluidly connecting the eighth communication hole, the ninth communication hole, and a central channel formed along a rotation axis of the valve body.

10. The valve assembly of claim 9, wherein in the first mode,
the third housing port, the fourth communication hole, the eleventh channel, the third communication hole, and the first manifold port are fluidly connected,
the sixth housing port, the seventh communication hole, the twelfth channel, the sixth communication hole, and the fifth housing port are fluidly connected,
the third manifold port, the ninth communication hole, the thirteenth channel, the eighth communication hole, and the second manifold port are fluidly connected, and
the third manifold port, the ninth communication hole, the thirteenth channel, and the central channel are fluidly connected.

11. The valve assembly of claim 8, wherein the second channel assembly includes:
a twenty-first channel configured to fluidly connect the first communication hole and a central channel formed along a rotation axis of the valve body;
a twenty-second channel configured to fluidly connect the second communication hole and the third communication hole;
a twenty-third channel configured to fluidly connect the fourth communication hole and the seventh communication hole;
a twenty-fourth channel configured to fluidically connect the fifth communication hole and the sixth communication hole; and
a twenty-fifth channel configured to fluidly connect the eighth communication hole and the ninth communication hole.

12. The valve assembly of claim 11, wherein
in the second mode,
the first housing port, the first communication hole, the twenty-first channel, and the central channel are fluidly connected,
the second housing port, the second communication hole, the twenty-second channel, the third communication hole and the first manifold port are fluidly connected,
the sixth housing port, the seventh communication hole, the twenty-third channel, the fourth communication hole, and the third housing port are fluidly connected,
the fourth housing port, the fifth communication hole, the twenty-fourth channel, the sixth communication hole, and the fifth housing port are fluidly connected, and
the third manifold port, the ninth communication hole, the twenty-fifth channel, the eighth communication hole, and the second manifold port are fluidly connected.

13. The valve assembly of claim 8, wherein the third channel assembly includes:
a thirty-first channel configured to fluidly connect the first communication hole and a central channel formed along a rotation axis of the valve body;
a thirty-second channel configured to fluidly connect the third communication hole and the ninth communication hole;
a thirty-third channel configured to fluidly connect the fourth communication hole and the eighth communication hole; and
a thirty-fourth channel configured to fluidly connect the sixth communication hole and the seventh communication hole.

14. The valve assembly of claim 13, wherein in the third mode,
the first housing port, the first communication hole, the thirty-first channel, and the central channel are fluidly connected,
the third manifold port, the ninth communication hole, the thirty-second channel, the third communication hole, and the first manifold port are fluidly connected,
the third housing port, the fourth communication hole, the thirty-third channel, the eighth communication hole, and the second manifold port are fluidly connected, and
the sixth housing port, the seventh communication hole, the thirty-fourth channel, the sixth communication hole, and the fifth housing port are fluidly connected.

15. The valve assembly of claim 8, wherein the fourth channel assembly includes:
a forty-first channel configured to fluidly connect the first communication hole and a central channel formed along a rotation axis of the valve body;
a forty-second channel configured to fluidly connect the third communication hole and the fourth communication hole;
a forty-third channel configured to fluidly connect the sixth communication hole and the seventh communication hole; and
a forty-fourth channel configured to fluidly connect the eighth communication hole and the ninth communication hole.

16. The valve assembly of claim 15, wherein in the fourth mode,
the first housing port, the first communication hole, the forty-first channel, and the central channel are fluidly connected,
the third housing port, the fourth communication hole, the forty-second channel, the third communication hole, and the first manifold port are fluidly connected,
the fifth housing port, the sixth communication hole, the forty-third channel, the seventh communication hole, and the sixth housing port are fluidly connected, and
the third manifold port, the ninth communication hole, the forty-fourth channel, the eighth communication hole, and the second manifold port are fluidly connected.

17. The valve assembly of claim 8, wherein the fifth channel assembly includes:
a fifty-first channel fluidly configured to connect the third communication hole, the ninth communication hole, and a central channel formed along a rotation axis of the valve body;
a fifty-second channel configured to fluidly connect the fourth communication hole and the eighth communication hole; and
a fifty-third channel configured to fluidly connect the sixth communication hole and the seventh communication hole.

18. The valve assembly of claim 17, wherein in the fifth mode,
the third manifold port, the ninth communication hole, the fifty-first channel, the third communication hole, and the first manifold port are fluidly connected,
the third manifold port, the ninth communication hole, the fifty-first channel, and the central channel are fluidly connected,
the third housing port, the fourth communication hole, the fifty-second channel, the eighth communication hole, and the second manifold port are fluidly connected, and
the sixth housing port, the seventh communication hole, the fifty-third channel, the sixth communication hole, and the fifth housing port are fluidly connected.

19. A valve assembly comprising:
a valve housing including a plurality of housing ports;
a valve manifold disposed in the valve housing and including a plurality of communication holes and at least one manifold port, the communication holes being fluidly connectable to the plurality of housing ports; and
a valve body rotatably disposed between the valve housing and the valve manifold and including:
a central channel formed along a rotational axis of the valve body, and
a plurality of channel assemblies formed at multiple positions in a circumferential direction of the valve body, each channel assembly including a plurality of channels selectively and fluidly connectable to at least one of the plurality of communication holes and to the central channel,
wherein, based on rotation of the valve body, one of the plurality of channel assemblies cooperates with the valve manifold and the valve housing to form a plurality of distinct coolant flow paths.

20. The valve assembly of claim 19, wherein the rotation of the valve body into different angular positions causes respective ones of the plurality of channel assemblies to be fluidly aligned with selected communication holes of the plurality of communication holes and housing ports of the plurality of housing ports, such that the valve assembly operates in a corresponding plurality of modes, each mode forming a distinct set of coolant flow paths.
